(19) United States
(12) Patent Application Publication
(10) Pub. No.: US 2021/0078883 A1
(43) Pub. Date: Mar. 18, 2021

(54) OIL-CONTAINING WASTEWATER TREATMENT METHOD AND EQUIPMENT WITH CREATING AND SAVING ENERGY EFFICIENCY

(71) Applicant: KUN SHAN UNIVERSITY, Tainan City (TW)

(72) Inventors: MING-CHIEN HSIAO, Tainan City (TW); MIAO-HSUAN HSIAO, Tainan City (TW); PO-HAN HSIAO, Tainan City (TW); RUEI-HENG WU, Tainan City (TW)

(73) Assignee: KUN SHAN UNIVERSITY, Tainan City (TW)

(21) Appl. No.: 17/023,383

(22) Filed: Sep. 17, 2020

(30) Foreign Application Priority Data
Sep. 17, 2019 (TW) 108133392

(51) Int. Cl. C02F 3/34; C02F 7/00; B01D 17/04; C02F 1/52; C02F 1/40; C02F 101/32; C02F 1/00

(52) U.S. Cl. CPC C02F 3/341; C02F 7/00; B01D 17/04; C02F 2001/007; C02F 1/40; C02F 2101/32; C02F 1/5236

(57) ABSTRACT

An oil-containing wastewater treatment method and equipment with creating and saving energy efficiency are disclosed. The method comprises the following steps of: providing the oil wastewater having a first COD value; performing the acidized demulsification treatment to the oil wastewater to separate the oil wastewater into upper layer solution and lower layer solution; performing the first coagulation sedimentation treatment to the lower layer solution to form the precipitate and upper clear solution; and performing the contact aeration treatment step to the upper clear solution by using the biological agent. Therefore, the inflow solution having a second COD value that meets the inflow standard can be obtained.

### CROSS-REFERENCE TO RELATED APPLICATION

This application claims priority from Taiwan Patent Application No. 108133392, filed on Sep. 17, 2019, in the Taiwan Intellectual Property Office, the content of which are hereby incorporated by reference in their entirety for all purposes.

### BACKGROUND OF THE INVENTION

### 1. Field of the Invention

The present invention relates to a wastewater treatment method and equipment, in particular with respect to an oil-containing wastewater treatment method and equipment with creating and saving energy efficiency.

### 2. Description of the Related Art

Incidents of illegally discharging oil-containing wastewater in countries around the world have been increasing year by year, mainly due to the excessively high technology and cost of oil-containing wastewater treatment. In the process of cutting, forming, grinding and processing metals and their alloys, a kind of lubricant, which is called cutting fluid, is usually used to cool and lubricate tools and workpieces. The cutting fluid needs to be replaced often, otherwise the processing effect of the workpieces will be not good, and therefore a large amount of cutting waste water is generated. The high content of oily substances (oil-containing substances) in cutting fluid, oily substances are insoluble in water, and the density of oil is lower than that of water. Therefore, if the oily substances are directly discharged into water bodies without treatment, the oily substances will float on the water surface. The air content in the water will be affected, leading to the death of plants and animals in the water. Over a long period of time, the water body will deteriorate and produce foul smell, which will eventually lead to pollution of the water body environment.

### SUMMARY OF THE INVENTION

In view of the aforementioned technical problems of the prior art, one purpose of the present invention is to provide an oil-containing wastewater treatment method and equipment with creating and saving energy efficiency to overcome the above-mentioned problems in connection with the prior art.

In order to accomplish the preceding purpose, the present invention provides an oil-containing wastewater treatment method with creating and saving energy efficiency, comprising the following steps: providing an oil-containing wastewater having a first COD value; performing an acidized demulsification treatment to the oil-containing wastewater to separate the oil-containing wastewater into an upper layer solution and a lower layer solution; performing a first coagulation sedimentation treatment to the lower layer solution to form a precipitate and an upper clear solution; and performing a contact aeration treatment to the upper clear solution by using a biological agent to obtain an inflow solution having a second COD value complying with an inflow standard, wherein the biological agent comprises a Bacillus subtilis, a natto bacteria, a lactic acid bacteria, a yeasts, a photosynthetic bacteria and a nitrifying bacteria.

Wherein the method further comprises performing a second coagulation sedimentation treatment to the upper clear solution between the first coagulation sedimentation treatment and the contact aeration treatment to obtain another upper clear solution followed by performing the contact aeration treatment to the another upper clear solution to obtain the inflow solution.

Wherein the method further comprises performing an anaerobic treatment to the upper clear solution between the first coagulation sedimentation treatment and the contact aeration treatment.

Wherein the biological agent comprises a mixture of a Bacillus subtilis, a natto bacteria, a lactic acid bacteria, a yeasts, a photosynthetic bacteria and a nitrifying bacteria with identical volume.

Wherein a pH value of the acidized demulsification treatment is 3.

Wherein the first coagulation precipitation treatment is performed by adding a coagulant, and the coagulant comprises a polyaluminum chloride (PAC) and a calcium chloride (CaCl₂).

Wherein the first coagulation precipitation treatment is performed by adding the coagulant comprising 30 ml/L polyaluminum chloride (PAC) and 4 g/L calcium chloride (CaCl₂).

Wherein a pH value of the first coagulation precipitation treatment is 9.

Wherein the second coagulation precipitation treatment is performed by adding the coagulant comprising 40 ml/L polyaluminum chloride (PAC) and 6 ml/L polyacrylamide (PAM).

Further, the present invention also provides an oil-containing wastewater treatment equipment with creating and saving energy efficiency for performing the aforementioned method, and the equipment comprises: an acidized demulsification treatment tank used for performing the acidized demulsification treatment to the oil-containing wastewater to separate the oil-containing wastewater into the upper layer solution and the lower layer solution; a plurality of coagulation sedimentation treatment tanks used for performing the first coagulation sedimentation treatment to the lower layer solution to form the precipitate and the upper clear solution; and a contact aeration treatment tank used for performing the contact aeration treatment to the upper clear solution by using the biological agent to obtain the inflow solution having the second COD value complying with the inflow standard.

In accordance with the preceding description, the oil-containing wastewater treatment method and equipment with creating and saving energy efficiency of the present invention may have one or more following advantages:

(1) Effectively treat the oil-containing wastewater (oily wastewater), reduce COD value, and improve COD removal rate.

(2) The energy required during the treatment process can be saved effectively.

(3) The wastewater can comply with the inflow standard after treatment.

(4) The produced waste residue (suspended solids) after treatment can be used as fuel to provide energy, and the effect of creating energy can be achieved.

### BRIEF DESCRIPTION OF THE DRAWINGS

FIG. 1 is a flow chart of the oil-containing wastewater treatment method with creating and saving energy efficiency of the present invention.

FIG. 2 is a schematic diagram of the oil-containing wastewater treatment equipment of the present invention.

### DETAILED DESCRIPTION OF THE PREFERRED EMBODIMENTS

For purposes of understanding the technical features, contents, advantages and technical effects achieved thereby, various embodiments of the present invention will now be described in more detail with reference to the accompanying drawings. Drawings are used for illustrating and assisting in understanding the detailed description, not represent the real scale and precise configuration of the present invention. Therefore, the claims cope of the subject matter are not interpreted or limited by the scale and configuration of the accompanying drawings. Further, for purposes of explanation, in the drawings, similar symbols typically identify similar components, unless context dictates otherwise. And the size and proportions of the components shown in the drawings are for the purpose of explaining the components and their structures only and are not intending to be limiting.

Unless otherwise noted, all terms used in the whole descriptions and claims shall have their common meaning in the related field in the descriptions disclosed herein and in other special descriptions. Some terms used to describe in the present invention will be defined below or in other parts of the descriptions as an extra guidance for those skilled in the art to understand the descriptions of the present invention.

The terms such as “first”, “second”, “third”, “fourth” used in the descriptions are not indicating an order or sequence, and are not intending to limit the scope of the present invention. They are used only for differentiation of components or operations described by the same terms.

Moreover, the terms “comprising”, “including”, “having”, and “with” used in the descriptions are all open terms and have the meaning of “comprising but not limited to”.

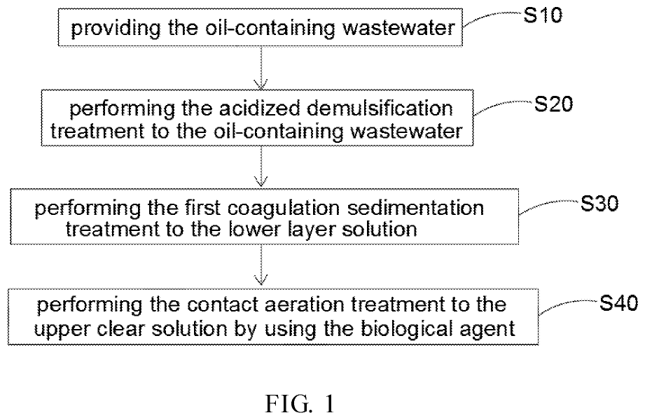

Please refer to FIG. 1, FIG. 1 is a flow chart of the oil-containing wastewater treatment method with creating and saving energy efficiency of the present invention. In the present invention, the value of the chemical oxygen demand (COD) in the cutting fluid wastewater can be reduced to comply with the inflow standard of the sewage factory in the industrial area, for example 800 mg/L, by performing the acidized demulsification treatment, the coagulation sedimentation treatment and the contact aeration treatment. As shown in FIG. 1, the present invention provides an oil-containing wastewater treatment method at least comprising steps S10 to S40. In step S10, the oil-containing wastewater is provided. Wherein the oil-containing wastewater has the first COD value. In step S20, the acidized demulsification treatment to the oil-containing wastewater is performed to separate the oil-containing wastewater into the upper layer solution and the lower layer solution. In step S30, the first coagulation sedimentation treatment to the lower layer solution is performed to form the precipitate and the upper clear solution. In step S40, the contact aeration treatment to the upper clear solution is performed by using the biological agent to obtain the inflow solution having the second COD value complying with the inflow standard.

In the present invention, the second coagulation sedimentation treatment to the upper clear solution obtained by the first coagulation sedimentation treatment can be optionally performed between the first coagulation sedimentation treatment (step S30) and the contact aeration treatment (step S40) to obtain another upper clear solution, and then the contact aeration treatment to the another upper clear solution can be performed to obtain the inflow solution. Additionally, the anaerobic treatment to the upper clear solution obtained by the coagulation sedimentation treatment(s) can be optionally performed between the first coagulation sedimentation treatment (step S30) and/or the second coagulation sedimentation treatment and the contact aeration treatment (step S40). In the same way, in the present invention, the third coagulation sedimentation treatment can be optionally performed after the second coagulation sedimentation treatment.

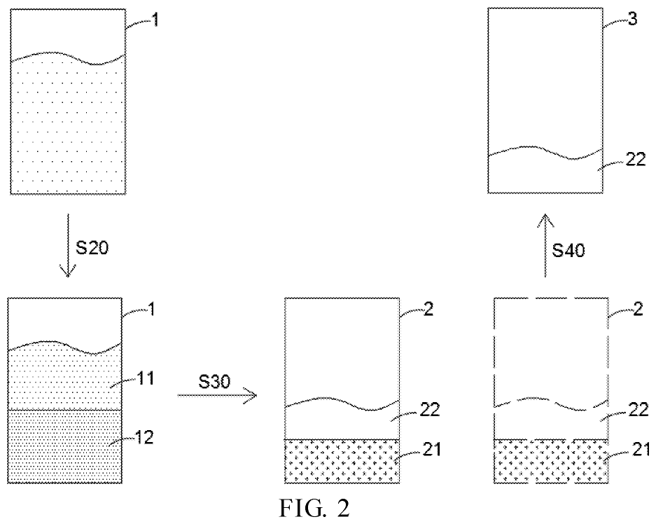

The oil-containing wastewater treatment equipment with creating and saving energy efficiency is used for performing the aforementioned oil-containing wastewater treatment method. Please refer to FIG. 2, FIG. 2 is a schematic diagram of the oil-containing wastewater treatment equipment of the present invention. As shown in FIG. 2, the oil-containing wastewater treatment equipment of the present invention at least comprises: the acidized demulsification treatment tank 1 used for performing the acidized demulsification treatment to the oil-containing wastewater (step S20) to separate the oil-containing wastewater into the upper layer solution 11 and the lower layer solution 12; a plurality of coagulation sedimentation treatment tanks 2 used for performing the first coagulation sedimentation treatment (step S30) to the lower layer solution 12 to form the precipitate 21 and the upper clear solution 22; and the contact aeration treatment tank 3 used for performing the contact aeration treatment (step S40) to the upper clear solution 22 by using the biological agent to obtain the inflow solution having the second COD value complying with the inflow standard. For example, 5 mL biological agent is added into the every 2 L upper clear solution 22. A filter material, such as the porous ceramic material, can be placed inside the above-mentioned contact aeration treatment tank 3, and the porous ceramic material can be for example the ceramic filter material of Pokka Biochemical Company, model S-101.

Specifically speaking, in the present invention, the complex treatment is performed to the raw liquid of the cutting oil wastewater (cutting fluid) having the COD value of 36,000 mg/L (even up to 72,000 mg/L). The COD value can be reduced to about 620 mg/L to comply with the requirements of inflow standard of the sewage factory in the industrial area (800 mg/L) and the wastewater can be effective discharged. Further, the oil-containing wastewater (raw liquid) having the COD value of 72,000 mg/L can be also treated by using the method and/or the equipment of the present invention. In the experiment of the present invention, the raw liquid of oil-containing wastewater is the cutting oil wastewater coming from the machine tool companies in Yongkang Industrial Area, Tainan City, Taiwan. The raw liquid is milky white with black solid floating on the upper layer and containing more brown-white oil. The pH of the raw liquid is within the range of 8-10.

The metal surface treatment includes hot treatment, cutting treatment and electroplating treatment, and large amount of cutting oil and lubricating oil are used during the metal surface treatment. Emulsion is currently the most widely used type of cutting fluid in production, and their basic components are made up of oil, water and various chemical additives. The commonly used cutting fluids in production are cutting oil, emulsion and aqueous solution. The cutting oil has good lubricity and anti-rust performance, but poor cooling and cleaning performance. When cutting, oil mist will be formed in the cutting area, causing environmental pollution. At the same time, oil resources are consumed and the production cost is high. Water-based cutting fluid has better cooling and cleaning performance, but poor anti-rust performance. The emulsion has a certain degree of lubricity, cooling, cleaning and anti-rust performance, and is currently the most widely used cutting fluid in production. The emulsion is prepared by diluting the pre-prepared emulsified oil with mineral oil, emulsifiers (such as sodium alkyl sulfonate, sulfonated castor oil, etc.) and additives. The emulsifier is a surfactant and its molecule is composed of polar groups and non-polar groups, therefore the emulsifier can dissolve oil in water. The emulsion containing less emulsified oil, that is low concentration (such as 3% to 5%), has better cooling and cleaning performance and is suitable for rough machining and grinding processing. The emulsion containing more emulsified oil, that is high concentration (such as 10% to 20%), has better lubricating performance and is suitable for precision machining processing (such as broaching and reaming, etc.). In order to further improve the lubricating performance of the emulsion, a certain amount of extreme pressure additives such as chlorine, sulfur, and phosphorus can be added to prepare the extreme pressure emulsion. These metal after cutting treatment are cleaned with large amount of water, therefore the oily emulsified wastewater will be produced. In addition, the waste gas produced by the quenching treatment is often treated by using the wet scrubber, thus producing oily emulsified wastewater. The oily emulsified wastewater is in the oil-in-water emulsified state, and its oil content is usually about 1% to 10%, and the rest is water. These wastewaters have high COD value and high suspended solids (SS) and are difficult to decompose.

In an embodiment of the oil-containing wastewater treatment method capable of creating and saving energy efficiency of the present invention, in order to obtain a better removal rate, the raw liquid of oil-containing wastewater (cutting oily wastewater) is first provided (step S10). Then, the acidized demulsification treatment to the oil-containing wastewater is performed (step S20). In Table 1, the COD removal rates are obtained by performing the acidification demulsification treatment 1 L raw liquid of oil-containing wastewater with 5 different pH values. In the acidification demulsification treatment of the present invention, first the oil-containing wastewater is mixed quickly at the stirring speed of 180 RPM for 20 minutes, and then standing for 30 minutes, the oil-containing wastewater will separated into the upper layer solution and the lower layer solution, and then measuring the COD value the oil-containing wastewater (lower layer solution). It can be seen from Table 1, after the acidification demulsification treatment with different pH values, the COD removal rate of pH 3 is higher than that of other pH values, and therefore the pH value of oil-containing wastewater should be adjusted to 3. By the way, the pH value is adjusted by placing 1 L raw liquid of the oil-containing wastewater in a 1 L beaker, and then adding concentrated hydrochloric acid to the oil-containing wastewater.

In the present invention, the COD value is measured by the detection method of chemical oxygen demand in water: potassium dichromate reflux method, according to the Taiwan Environmental Protection Agency Inspection No. 0960058228 announcement on Aug. 1, 2007.

The outline of the method is: adding excess potassium dichromate solution to the water sample, refluxing in about 50% sulfuric acid solution, and then titrating the remaining potassium dichromate with ferrous ammonium sulfate solution. The chemical oxygen demand (COD) in water sample, which represents the content of oxidizable organic matter in the sample, can be obtained by calculating the consumed amount of potassium dichromate,

TABLE 1
COD removal effect of different pH values in acidification
demulsification treatment

| | raw | | | | | |
|---|---|---|---|---|---|---|
| | liquid | pH 1 | pH 2 | pH 3 | pH 4 | pH 5 |
| COD (mg/L) | 36,000 | 25,200 | 22,680 | 16,380 | 18,900 | 27,720 |
| COD | | 30% | 37% | 54% | 47% | 44% |
| removal rate (%) | | | | | | |

In step S30, the first coagulation sedimentation treatment to the lower layer solution separated by the acidized demulsification treatment (step S20) is performed to form the precipitate and the upper clear solution. In Table 2, the COD removal rates are obtained by performing the coagulation sedimentation treatment with different dosages (10 ml-20 ml-30 ml-40 ml-50 ml-60 ml) of PAC (CaCl₂ is fixed at 4 g/L). Detailed speaking, polyaluminum chloride (PAC) in different dosage (10 ml, 20 ml, 30 ml, 40 ml, 50 ml, 60 ml) are added into 1 L of the raw liquid of oil-containing wastewater respectively, and then calcium chloride CaCl₂) (4 g/L) are added and mixed quickly (100 RPM) for 1 minute and mixed slowly (50 RPM) for 20 minutes. After 30 minutes of precipitation, measure the COD value of the upper clear solution to calculate and obtain the COD removal rate. It can be seen from Table 2, the COD removal effect will increase if increasing the PAC dosage. When the PAC dosage is 30 ml/L, the COD removal rate can reach 54%.

However, when the PAC dosage exceeds 30 ml/L, the COD removal effect will not increase significantly, and the COD removal rate is not much different. The reason is that when the PAC is excessive, the distance between the colloidal particles changes the Van der Waals force between the colloidal particles. The van der Waals force of colloidal particles of PAC in water is significantly higher than the Brownian motion that produces water molecule collision. Therefore, under the appropriate dosage of PAC, although the COD removal rate can be proportional, when the dosage is excessive, the COD removal rate will be inversely proportional. Therefore, in order to consider the cost, the PAC dosage used in the present invention is preferably 30 ml/L.

TABLE 2
COD removal effect of different
dosages of PAC (CaCl₂ is fixed at 4 g/L)

| | raw | | | | | | |
|---|---|---|---|---|---|---|---|
| | liquid | 10 | 20 | 30 | 40 | 50 | 60 |
| COD | 36,000 | 18,720 | 18,720 | 16,560 | 16,560 | 15,600 | 16,120 |
| (mg/L) | | | | | | | |
| COD | | 48% | 48% | 54% | 54% | 56% | 55% |
| removal | | | | | | | |
| rate (%) | | | | | | | |

Table 3 represents the COD removal effects of 1 L oil-containing wastewater (raw liquid) in different pH values.

First the raw liquid is adjusted in different pH values (pH 4, 5, 6, 7, 8, 9), and then PAC (30 ml/L) and CaCl₂ (4 g/L) are added and mixed quickly (100 RPM) for 1 minute and mixed slowly (50 RPM) for 20 minutes. After 30 minutes of precipitation, measure the COD value of the upper clear solution to calculate and obtain the COD removal rate. It can be seen from Table 3, when the pH value is 4 or 9, the COD removal rate is better, reaching 51% (pH 4) and 53% (pH 9) respectively. Since the pH value of 9 is closer to the pH value of the raw liquid of the oil-containing wastewater (pH 8.7), the preferred pH value is 9 in the coagulation sedimentation treatment.

TABLE 3
COD removal effect of the cutting oil wastewater in different pH
values (PAC is fixed at 30 ml/L, and CaCl₂ is fixed at 4 g/L)

| | raw | | | | | | |
|---|---|---|---|---|---|---|---|
| | liquid | pH 4 | pH 5 | pH 6 | pH 7 | pH 8 | pH 9 |
| COD | 36,000 | 17,680 | 19,380 | 35,600 | 28,080 | 21,600 | 16,720 |
| (mg/L) | | | | | | | |
| COD | | 51% | 46% | 1.1% | 22% | 40% | 53% |
| removal | | | | | | | |
| rate (%) | | | | | | | |

Additionally, in the present invention, the second coagulation sedimentation treatment (the second-time coagulation sedimentation treatment) can be optionally performed after the first coagulation sedimentation treatment (step S30). As shown in Table 4, the coagulation sedimentation treatment is performed according to the best results obtained in Table 2 and Table 3, wherein PAC is 30 ml/L, CaCl₂ is 4 g/L, pH is 9, and mixed quickly (100 RPM) for 1 minute and mixed slowly (50 RPM) for 20 minutes. After 30 minutes of precipitation, divide the upper layer solution into 10 cups (500 ml per cup). Take 5 cups of the 10 cup. The second coagulation sedimentation treatment is performed to these 5 cups, adjust different PAC dosage (20 ml/L, 30 ml/L, 40 ml/L, 50 ml/L, 60 ml/L), and then add PAM (6 ml/L), mixed quickly (100 RPM) for 1 minute and mixed slowly (50 RPM) for 20 minutes. After 30 minutes of precipitation, measure the COD value of the upper clear solution to calculate and obtain the COD removal rate, which are recited in Table 4. It can be seen from Table 4, when the cutting oil wastewater is treated by the second coagulation sedimentation, the COD removal rate can reach 64% if adding 40 ml/L PAC.

TABLE 4
COD removal effect of the cutting oil wastewater in
different dosages of PAC in the second coagulation
sedimentation treatment (PAM is fixed at 6 ml/L)

| | raw | | | | | |
|---|---|---|---|---|---|---|
| | liquid | 20 ml/L | 30 ml/L | 40 ml/L | 50 ml/L | 60 ml/L |
| COD | 36,000 | 24,480 | 21,600 | 12,960 | 15,840 | 17,280 |
| (mg/L) | | | | | | |
| COD | | 32% | 40% | 64% | 56% | 48% |
| removal | | | | | | |
| rate (%) | | | | | | |

Further, take the remaining 5 cups of the aforementioned 10 cup. The PAC dosage is fixed, and the PAM is adjusted in different dosage (2 ml/L, 4 ml/L, 6 ml/L, 8 ml/L, 10 ml/L), and mixed quickly (100 RPM) for 1 minute and mixed slowly (50 RPM) for 20 minutes. After 30 minutes of precipitation, measure the COD values, which are recited in Table 5. It can be seen from Table 5, after the cutting oil wastewater treated by the second coagulation sedimentation, the COD removal rate is best and can reach 60% when the PAC is 40 ml/L and PAM is 6 ml/L. Therefore, 6 ml/L of PAM is selected as the best value.

TABLE 5
COD removal effect of the cutting oil wastewater in
different dosages of PAM in
the second coagulation sedimentation treatment

| | raw | | | | | |
|---|---|---|---|---|---|---|
| | liquid | 2 ml/L | 4 ml/L | 6 ml/L | 8 ml/L | 10 ml/L |
| COD | 36,000 | 23,040 | 20,600 | 14,400 | 17,280 | 18,720 |
| (mg/L) | | | | | | |
| COD | | 36% | 44% | 60% | 52% | 47% |
| removal | | | | | | |
| rate (%) | | | | | | |

It can be seen from Table 1, the pH value in the acidification demulsification treatment (step S20) is preferably 3. Therefore, in the present invention, the pH value of the oil-containing wastewater is adjusted to 3, and the mixture is quickly mixed at a stirring speed of 180 RPM for 20 minutes. After standing for 30 minutes (30 minutes of precipitation), the lower layer solution is siphoned to measure the COD value. It can be seen from Tables 2 and 3, the pH value in the first coagulation sedimentation treatment (step S30) is preferably 9 with PAC (30 ml/L) and CaCl₂ (4 g/L), and mixed quickly (100 RPM) for 1 minute and mixed slowly (50 RPM) for 20 minutes. After 30 minutes of precipitation, measure the COD value of the upper clear solution. It can be seen from Tables 4 and 5, the coagulant is preferably PAC (40 ml/L) and PAM (6 ml/L) used in the second coagulation sedimentation treatment to the upper clear solution obtained by the first coagulation sedimentation treatment, and mixed quickly (100 RPM) for 1 minute and mixed slowly (50 RPM) for 20 minutes. After 30 minutes of precipitation, measure the COD value of the upper clear solution and the results are listed in Table 6. It can be seen from Table 6, the COD removal rate of the cutting oil wastewater after the acidification demulsification treatment and two-times coagulation sedimentation treatment can reach 95%.

TABLE 6
total COD removal effect obtained by acidification
demulsification treatment and second coagulation sedimentation
treatment to the cutting oil wastewater

| | | | | | acidification |
|---|---|---|---|---|---|
| | | | first | second | demulsification |
| | | acidi- | coagu- | coagu- | treatment and |
| | | fication | lation | lation | second |
| | | demulsi- | sedimen- | sedimen- | coagulation |
| | raw | fication | tation | tation | sedimentation |
| | liquid | treatment | treatment | treatment | treatment |
| COD (mg/L) | 36,000 | 18,000 | 4,840 | 1,920 | |
| COD | | 50% | 73% | 60% | |
| removal rate | | | | | |
| (%) | | | | | |
| Total COD | | | | | 95% |
| removal rate | | | | | |
| (%) | | | | | |

In the method of the present invention, the contact aeration treatment (step S40), that is an aerobic treatment, is further performed after acidification demulsification treatment and two-times coagulation sedimentation treatment. In the contact aeration treatment, the biological agent is added, wherein 5 ml liquid biological agent is preferably added in every 2 L solution to be treated (for example, the above-mentioned upper clear solution 22). The biological agent is, for example, oil-decomposing bacteria with oil-decomposing properties, and preferably comprising the mixture of the Bacillus subtilis, the natto bacteria, the lactic acid bacteria, the yeasts, the photosynthetic bacteria and the nitrifying bacteria with identical volume. For example, the volume ratio of the Bacillus subtilis, the natto bacteria, the lactic acid bacteria, the yeasts, the photosynthetic bacteria and the nitrifying bacteria is substantially 1:1:1:1:1:1. The biological agent is preferably prepared by the bacteria (10⁸ bacteria per gram) purchased from Yangtian Biotechnology Co., Ltd. and cultured in liquid for three days, and then mixed in equal proportions. The source of the oil-decomposing strain is preferably commercially available. In addition to being commercially available, it can also be selected from grease-contaminated sites or fermented fertilizers, or a mixture of commercially available and planting bacteria. In addition, the porous ceramic filter materials can also be introduced at the same time to increase reaction efficiency. In the present invention, biological agent can also be obtained, for example, through a bacterial planting step, that is, the sludge from the aeration tank (activated sludge of oily wastewater treatment) is planted into the aeration tank for contact aeration treatment, and the sludge accounts for more than ⅕ of the volume of the aeration tank. The ratio of the amount of organic matter flowing into the aeration tank per day to the amount of sludge in the aeration tank is preferably 0.2 to 0.5 kg BODS/kg MLVSS-day, the dissolved oxygen content is 2 to 4 mg/L, and the nutrient source phosphorus content is 0.5 to 1 mg/L. In Tables 7 to 9, the artificial wastewater is prepared with a ratio of COD:N:P in 100:5:1, respectively, with sucrose, ammonium chloride and potassium dihydrogen phosphate.

It can be seen from Table 7, the COD removal rate of the artificial wastewater in different concentrations can reach more than 90% after the sludge planting.

TABLE 7
COD removal effect of contact aeration treatment
to the artificial wastewater

| | Artificial | | COD |
|---|---|---|---|
| | wastewater | COD | removal |
| Date | concentration | (mg/L) | rate (%) |
| 2018 Jun. 7 | 600 | 56 | 91% |
| 2018 Jun. 17 | 800 | 60 | 92% |
| 2018 Jun. 21 | 1,000 | 48 | 95% |

It can be seen from Table 8, the contact aeration method is used to treat the cutting oil wastewater, and nitrogen source is additionally added (ammonium chloride and potassium dihydrogen phosphate with a ratio of COD:N:P in 100:5:1). The COD removal rate will be getting worse when the concentration increases. When the COD value is increased to 3,000 mg/L, the COD removal rate can only reach a removal rate of 48%, and the outflow COD can only reach 1,560 mg/L, which still does not comply with the 800 mg/L standard for inflow water of industrial wastewater plants.

TABLE 8
COD removal effect of contact aeration treatment to
the cutting oil wastewater

| | cutting oil | | |
|---|---|---|---|
| | wastewater | COD | COD |
| Date | concentration | (mg/L) | removal rate (%) |
| 2018 Jun. 24 | 1,200 | 112 | 90% |
| 2018 Jul. 4 | 1,800 | 560 | 69% |
| 2018 Jul. 21 | 2,400 | 920 | 61% |
| 2018 Aug. 3 | 3,000 | 1,770 | 41% |
| 2018 Aug. 6 | 3,000 | 1,560 | 48% |

TABLE 9
COD removal effect of contact aeration and oil decomposing
bacteria treatment to the cutting oil wastewater

| | cutting oil | | |
|---|---|---|---|
| | wastewater | COD | COD |
| Date | concentration | (mg/L) | removal rate (%) |
| 2018 Jul. 20 | 3,000 | 1,320 | 56% |
| 2018 Aug. 3 | 2,500 | 875 | 65% |
| 2018 Aug. 17 | 2,500 | 620 | 75.2% |
| 2018 Aug. 20 | 3,000 | 640 | 78.7% |
| 2018 Aug. 23 | 3,000 | 560 | 81.3% |

As shown in Table 8, by using contact aeration method to treat cutting oil wastewater, and nitrogen source is additionally added (ammonium chloride and potassium dihydrogen phosphate with a ratio of COD:N:P in 100:5:1), the outflow COD value can only reach 1,560 mg/L. However, as shown in Table 9, if the biological agent of the present invention is added, the COD value of the outflow can be 560 mg/L, which already comply with the inflow water standard of 800 mg/L for industrial wastewater treatment plants.

Based on the above descriptions, the oil-containing wastewater treatment method and equipment with creating and saving energy efficiency of the present invention may have one or more following advantages:

(1) Effectively treat the oil-containing wastewater (oily wastewater), reduce COD value, and improve COD removal rate.

(2) The energy required during the treatment process can be saved effectively.

(3) The wastewater can comply with the inflow standard after treatment.

(4) The produced waste residue (suspended solids) after treatment can be used as fuel to provide energy, and the effect of creating energy can be achieved.

While the invention has been described by way of example(s) and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An oil-containing wastewater treatment method with creating and saving energy efficiency, comprising the following steps:
providing an oil-containing wastewater having a first COD value;
performing an acidized demulsification treatment to the oil-containing wastewater to separate the oil-containing wastewater into an upper layer solution and a lower layer solution;
performing a first coagulation sedimentation treatment to the lower layer solution to form a precipitate and an upper clear solution; and
performing a contact aeration treatment to the upper clear solution by using a biological agent to obtain an inflow solution having a second COD value complying with an inflow standard, wherein the biological agent comprises a Bacillus subtilis, a natto bacteria, a lactic acid bacteria, a yeasts, a photosynthetic bacteria and a nitrifying bacteria.

2. The method of claim 1, further performing a second coagulation sedimentation treatment to the upper clear solution between the first coagulation sedimentation treatment and the contact aeration treatment to obtain another upper clear solution followed by performing the contact aeration treatment to the another upper clear solution to obtain the inflow solution.

3. The method of claim 1, further performing an anaerobic treatment to the upper clear solution between the first coagulation sedimentation treatment and the contact aeration treatment.

4. The method of claim 1, wherein the biological agent comprises a mixture of a Bacillus subtilis, a natto bacteria, a lactic acid bacteria, a yeasts, a photosynthetic bacteria and a nitrifying bacteria with identical volume.

5. The method of claim 2, wherein a pH value of the acidized demulsification treatment is 3.

6. The method of claim 1, wherein the first coagulation precipitation treatment is performed by adding a coagulant, and the coagulant comprises a polyaluminum chloride (PAC) and a calcium chloride (CaCl₂).

7. The method of claim 6, wherein the first coagulation precipitation treatment is performed by adding the coagulant comprising 30 ml/L polyaluminum chloride (PAC) and 4 g/L calcium chloride (CaCl₂).

8. The method of claim 5, wherein a pH value of the first coagulation precipitation treatment is 9.

9. The method of claim 8, wherein the second coagulation precipitation treatment is performed by adding the coagulant comprises 40 ml/L polyaluminum chloride (PAC) and 6 ml/L polyacrylamide (PAM).

10. An oil-containing wastewater treatment equipment with creating and saving energy efficiency for performing the method as recited in claim 1, the equipment comprising:
an acidized demulsification treatment tank used for performing the acidized demulsification treatment to the oil-containing wastewater to separate the oil-containing wastewater into the upper layer solution and the lower layer solution;
a plurality of coagulation sedimentation treatment tanks used for performing the first coagulation sedimentation treatment to the lower layer solution to form the precipitate and the upper clear solution; and
a contact aeration treatment tank used for performing the contact aeration treatment to the upper clear solution by using the biological agent to obtain the inflow solution having the second COD value complying with the inflow standard.
